(19) United States
(12) Patent Application Publication
(10) Pub. No.: US 2021/0229370 A1
(43) Pub. Date: Jul. 29, 2021

(54) Automated System for Gluing or Separating Modified Adhesives and Joining or Separating Plastic Materials Through the Use of Nanoparticles Sensitive to Electromagnetic Fields, on an Industrial Scale

(71) Applicant: Politecnico Di Torino, Torino (TO) (IT)

(72) Inventors: Raffaele Ciardiello, Torino (IT); Giovanni Belingardi, Torino (IT)

(21) Appl. No.: 15/734,801

(22) PCT Filed: Jun. 3, 2019
(86) PCT No.: PCT/IB2019/054579

§ 371 Date: Dec. 3, 2020

(30) Foreign Application Priority Data
Jun. 4, 2018 (IT) 102018000006015

(51) Int. Cl. B29C 65/36; B29C 65/48; B29C 65/00; C08K 3/22; C09J 9/00; C09J 5/06

(52) U.S. Cl. CPC B29C 65/3668; B29C 65/4815; B29C 66/863; B82Y 30/00; C08K 3/22; C09J 9/00; C09J 5/06; B29C 66/836

(57) ABSTRACT

A process for gluing on an industrial scale, preferably by using hot-melt adhesives, substrates, preferably made of plastic material, by nano-modifying the adhesives through the addition of particles sensitive to electromagnetic fields and electromagnetic induction coupling. The present invention also relates to a simple, low-cost and environment-friendly (i.e., eco-compatible) separation of various components glued by way of the adhesives through the use of the same equipment and the same type of process. Furthermore, the present invention also relates to repairing glued junctions made by way of the adhesives.

### BACKGROUND OF THE INVENTION

### Technical Field

The present invention relates to a process that allows simplifying and applying on an industrial scale the gluing/joining, preferably by using thermoplastic adhesives of the type commonly known as “hot-melt” (but also any other thermoplastic adhesive in general), of components/substrates made of plastic material (and possibly also composite materials comprising any type of fiber and/or metal) by nano-modifying said adhesives through the addition of nanoparticles sensitive to electromagnetic fields and electromagnetic induction coupling. Said gluing/joining is effected by means of a thin layer of said adhesive modified with said nanoparticles.

The present invention also relates to a simple, low-cost and environment-friendly (i.e., eco-compatible) separation of plastic components/substrates pre-glued with said adhesives through the use of the same equipment and the same type of process.

Furthermore, the present invention also relates to repairing, whenever necessary, the gluing/junctions of plastic components/substrates made by means of said adhesives. In particular, the present invention aims at solving the following industrial problems.
1. Gluing/joining components/substrates having various compositions of plastic materials (more preferably plastic materials, but possibly also composite materials with any type of fibers and/or metals and/or combinations thereof), of different dimensions and, possibly, also having complex gluing lines.
2. Separating said components/substrates, more preferably plastic, pre-glued with said thermoplastic adhesives without damaging the said components, even when the adhesive is not in view.
3. Allowing for diversified recycling (if different materials are involved), reusing and process waste reducing.
4. Allowing for the repairing, whenever necessary and/or preferable, of said gluing/junctions.
5. Reducing equipment, space, and the number of operators required for gluing and/or separating said components, preferably plastic, with said thermoplastic adhesives, thus also allowing for the industrial application of the process according to the invention.

### Background Art

### Shortcomings of the Prior Art

With the use of today's technologies, the separation of components glued/joined with thermoplastic adhesives cannot be effected without causing damages to the glued components. For example, the separation options that are currently available are limited to:
separating glued components by mechanically cutting the adhesive, which may imply cutting the components (resulting in formation of scraps), since the adhesives are not always in view;
separating the components by heating them up to the adhesive's melting temperature; for many plastic components, this technique may result in the deformation thereof, since the separation temperatures (i.e., the adhesive's melting or fluidization temperatures) may be higher than the temperature at which the components to be separated soften or become deformed; this often results in irreversible damages to the components, which cannot be reused;
the separation through the use of chemical agents, which may however corrode or be detrimental to the glued components.

Patent Application US 2016/0284449 A1 attempts to solve the problem of gluing and separating metallic, composite and hybrid materials only. Such technique utilizes microwaves and electromagnetic fields along with thermoplastic adhesives and generic carbon-based and/or iron-based particles. The described technique is not applicable at industrial level.

U.S. Pat. No. 4,538,279 describes the use of a pancake and a spiral coil for different applications.

U.S. Pat. No. 6,849,837 melts the adhesive by means of electromagnetic induction, without however using nanoparticles.

### Technical Problem

Therefore, a need is still strongly felt by industry operators for a reliable, easy-to-implement and low-cost industrial process for gluing/joining components/substrates, preferably made of plastic, through the use of a thermoplastic adhesive, and/or for separating said glued components without damaging them, thus allowing for the recycling, reuse, waste reduction thereof and/or for repairing said gluing/junctions.

It is the object of the present invention to provide an adequate solution to the above-described technical problem.

### Summary Description of the Invention

The present inventors have now found that the use of a thermoplastic adhesive, preferably of the hot-melt type, with the addition of an effective amount of nanoparticles of iron oxide Fe₃O₄ (or nano-magnetite), heated by a suitable specific electromagnetic inductor, can provide an adequate solution to the technical problem highlighted above.

Therefore, it is one object of the present invention an industrial process for gluing/joining plastic components/substrates of any type, shape and size by means of the above-described modified thermoplastic adhesive, as set out in the appended independent claim.

It is another object of the present invention an industrial process for separating the plastic components pre-glued by the above-described modified thermoplastic adhesive, as set out in the appended independent claim.

It is a further object of the present invention an industrial process for repairing the gluing/junction of plastic components/substrates in which said gluing/junction is damaged or broken, as set out in the appended independent claim.

Preferred embodiments of the present invention are set out in the appended dependent claims.

The preferred embodiments of the present invention illustrated in the following description only have been reported by way of example, and are by no means intended to limit the application scope of the present invention, which will be immediately apparent to those skilled in the art.

### BRIEF DESCRIPTION OF THE DRAWINGS

FIG. 1 photographically illustrates a preferred embodiment of a flat spiral pancake coil which can advantageously be used for the purposes of the present invention.

FIG. 2 photographically illustrates an embodiment of a traditional coil, which is not particularly preferred for use for the purposes of the present invention.

FIG. 3 shows a scheme of application of glue according to the present invention.

FIG. 4 is a scheme that illustrates one possible round, flat spiral pancake coil of the present invention, possibly usable in combination with a cooling jet, and the operation thereof.

FIG. 5 shows a sample subjected to a gluing test carried out by applying the process of the present invention.

FIG. 6 shows the separation surfaces of a polyolefin-based thermoplastic adhesive of the present invention with three different weight concentrations of nanoparticles in the thermoplastic adhesive.

FIG. 7 illustrates the steps of heating, by electromagnetic induction, a sample glued with the modified thermoplastic adhesive of the present invention to achieve separation of the glued parts.

### DETAILED DESCRIPTION OF THE INVENTION

The present invention concerns an industrial process for gluing/joining at least two components or substrates, more preferably made of plastic material, of various type, shape and size, preferably selected from the group consisting of polypropylene, polyethylene, and copolymers thereof (but possibly also polystyrene, nylon, epoxy plastic materials, and all the composite material obtainable therefrom), by means of a thermoplastic adhesive (preferably selected from those commonly known as hot-melt adhesives, e.g., selected from the group consisting of polyamides, polyesters, polyurethanes, acrylonitrile-butadiene-styrene (ABS) copolymers, styrene block copolymers, polycarbonates, polyolefins, ethylene-vinyl acetate copolymers, ethylene-acrylate copolymers, and combinations thereof) modified through the addition of an effective amount of nanoparticles of iron oxide Fe₃O₄ (or nano-magnetite); said modified adhesive is first applied to the gluing area or points of at least one of the two components/substrates to be glued together; then, after the components to be glued have been placed in mutual contact, and possibly under pressure, the adhesive is heated until it fluidizes or melts by means of an externally applied electromagnetic inductor; finally, after the electromagnetic inductor has been removed, said modified adhesive is cooled or left to cool (possibly still under pressure) until it reaches the solid state and gives the desired gluing/junction.

In a similar manner, electromagnetic induction can be applied to the gluing/joining area or points of at least two plastic components pre-glued/joined by means of the above-described process until fluidization or melting of said modified thermoplastic adhesive is achieved; afterward, said at least two components, preferably made of plastic material, can be easily separated/detached from each other without causing any damage thereto.

In an equally similar manner, by successively applying the above-described methods it is possible to detach from each other at least two components, preferably made of plastic material, in which the thermoplastic junction is damaged or broken, and then glue them again together to obtain a perfectly repaired (i.e., re-glued) product having the same characteristics as the original glued product.

In the thermoplastic adhesive of the present invention, the added iron oxide nanoparticles (consisting of nanoparticles of nano-magnetite, Fe₃O₄) have a mean size <50 nm; preferably, smaller than 45 nm; preferably, smaller than 40 nm; more preferably, smaller than 35 nm; more preferably, smaller than 30 nm; even more preferably, smaller than 25 nm, depending on the type(s) of plastic material(s) to be glued and/or the type of junction to be obtained; specifically, said nano-magnetite nanoparticles preferably have a size in the range of 12 to 50 nm or, preferably, in the range of 12 to 40 nm or, preferably, in the range of 12 to 30 nm, depending on the type of plastic material(s) to be glued and/or the type of junction to be obtained. The present inventors have found that nanoparticles of the above-mentioned type and sizes allow for faster melting of the adhesive. Bigger particles require higher weight percentages (of such particles) in the adhesive to ensure equally fast heating. This would result in a drawback in terms of total weight and cost of the adhesive, and hence of the manufactured product.

In said thermoplastic adhesives of the present invention, the added nanoparticles of iron oxide Fe₂O₃ (or nano-magnetite) are present in an amount from 3% to 30% by weight. For example, they are present in an amount of 30% w/w to ensure very fast heating of the adhesive, 10% for a relatively fast heating (a good compromise between heating rate and cost of the nanoparticles), and 3% or 5% for slow melting of the adhesive.

The present invention makes it possible to simplify and improve the gluing/joining, on an industrial scale, of at least two components, preferably plastic (but, possibly, also composite materials having any type of fibers and/or metallic materials, and/or combinations thereof) through the use of any type of thermoplastic adhesive, preferably of the hot-melt type, modified in accordance with the invention, and also makes it possible to separate said components previously glued together with the same adhesives. As is known, thermoplastic adhesives are special adhesives that must be heated up to their fluidization or melting point, to be used, and, after their application, cooled to solidification until gluing is obtained. In this invention, thermoplastic adhesives are modified by adding an effective amount of nanoparticles of iron oxide Fe₃O₄ (or nano-magnetite) having sizes smaller than 50 nm, preferably in the range of 12 to 50 nm, or preferably in the range of 12 to 40 nm, or preferably in the range of 12 to 30 nm, as previously described. In said thermoplastic adhesives, the added nano-magnetite nanoparticles are present in an amount from 3% to 30% w/w, as previously described. In this way, the modified thermoplastic adhesive can be heated by means of an external electromagnetic inductor, thanks to the introduction of said metallic particles into the adhesive, which are excited by the magnetic field generated by the inductor. Thus, the nano-magnetite nanoparticles act as heat sources for the adhesive and allow, according to the size and weight percentage thereof, the adhesive to melt. Heating times decrease as the percentage of nano-magnetite particles increases. The nano-magnetite nanoparticles must be well dispersed in the thermoplastic adhesive matrix to ensure uniform heating. For this reason, the nanoparticles are scattered by using efficient scattering systems, such as extruders, also known as three-roll mills, or common mixing systems wherein dissolution and/or mixing into the polymer are achieved through sonication (i.e., ultrasound) in order to achieve better particle dispersion.

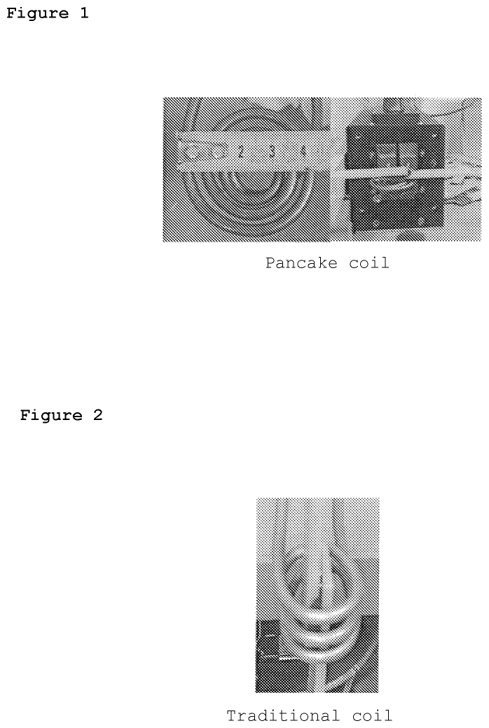

In a particularly preferred embodiment, the invention uses, as a heating element, an electromagnetic inductor, more preferably an electromagnetic inductor having a suitably shaped and sized head. For the purposes of the present invention, the most preferred inductor is an electromagnetic inductor with a so-called pancake head, as shown by way of non-limiting example in the annexed FIG. 1. In said pancake inductor, the number of turns of the coil may vary according to the desired type of gluing line; this also applies to the shape of the same, which may be, for example, square or circular (or of any other suitable shape). This type of coil is not described nor suggested to the inventors in the prior art; it is very flexible and versatile compared to traditional coils because it can be passed in a continuous manner over the adhesive strip to be melted. In a pancake coil (such as, for example, the one described in FIG. 1), the adhesive heating temperature is highest near the coil center and decreases towards the outer turns. This effect turns out to be particularly beneficial because the peripheral turns of the pancake coil provide pre-heating for the adhesive line.

Traditional coils do not have such flexibility and are normally designed to embrace the shape of the object to be heated, as shown in the annexed FIG. 2. In this case, the maximum magnetic field, i.e., maximum heating, is obtained at the center of the coil. Unlike a pancake coil, however, this type of coil cannot be adapted to any type of application and has to be specially designed and manufactured for each individual application. Moreover, it suffers from the drawback that the frequency of the magnetic field generated by the coil decreases as the coil length increases, which is a very important factor in view of obtaining an effective melting of the adhesive. In addition, a pancake coil may have small shapes and dimensions while generating a high-frequency magnetic field, resulting in shorter heating times, which in turn result in an advantage in terms of integrity of the plastic components to be glued/joined.

The invention allows implementing an automated process for gluing/joining and separating components preferably made of plastic material, or possibly also composite materials or metallic materials, or combinations thereof. For example, carbon-fiber composite materials and metallic materials must be suitably cooled, because the induction process may also lead to increased temperature of the components. In this case, an airflow must be used in order to cool down the surface of the components to be glued, according to the material's sensitivity to electromagnetic fields. In this manner, the components to be glued are not subject to heating and risk of damage. Plastics and glass-fiber composite materials do not need these precautions, since they are transparent to electromagnetic fields. However, cooling the surface of plastic components was observed to be useful (or even necessary) when the melting temperature of the thermoplastic adhesive was very similar to the softening/deformation temperature of the plastic components to be glued or separated.

In one embodiment, the invention uses a support surface whereon the base of the first component to be glued, preferably made of plastic material, must be positioned. This component may, for example, be provided with a strip (or spots) of the thermoplastic adhesive modified with nano-magnetite particles according to the invention, pre-glued at the location or points where gluing will have to occur. As an alternative, the above-mentioned modified adhesive may be positioned at the desired points by a robot/worker. Once the adhesive has been applied, the second component to be glued, preferably made of plastic material, is positioned on the first component, preferably under light pressure, and, through the use of a suitable pancake-coil inductor mounted, for example, on a manually or automatically controlled robotic arm, which is made to pass externally over the adhesive line or points, appropriate fluidization or melting of the adhesive is achieved. The pressure exerted on the component 1 by the component 2 allows the melted adhesive to spread evenly on the selected points for perfect gluing.

The separation process can be carried out in the reverse order, i.e., by first melting the adhesive and then detaching the pre-glued components. The same adhesive can be reused many times, if the adhesive's decomposition temperature is not exceeded. This also allows repairing any glued junction that, for any reason, has undergone damage (e.g., the formation of cracks) or breakage.

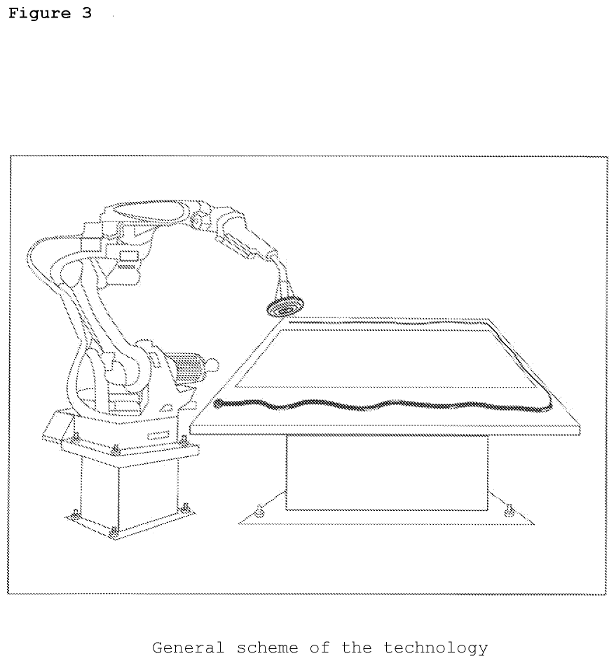

Merely by way of non-limiting example of the broad application potential of the invention, the annexed FIG. 3 shows a simplified view of one possible application of the invention. For simplicity's sake, FIG. 3 does not show the second component to be laid on and glued to the first component. It is thus possible to see the pancake coil mounted on a mechanical arm, which can be moved along the adhesive line of the invention.

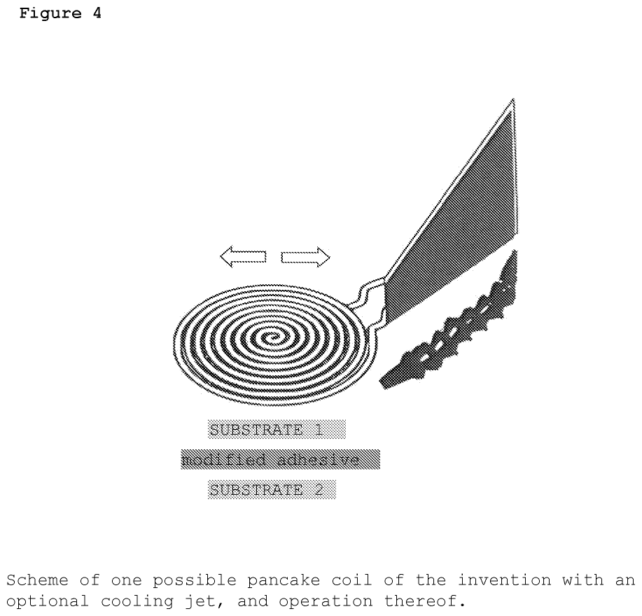

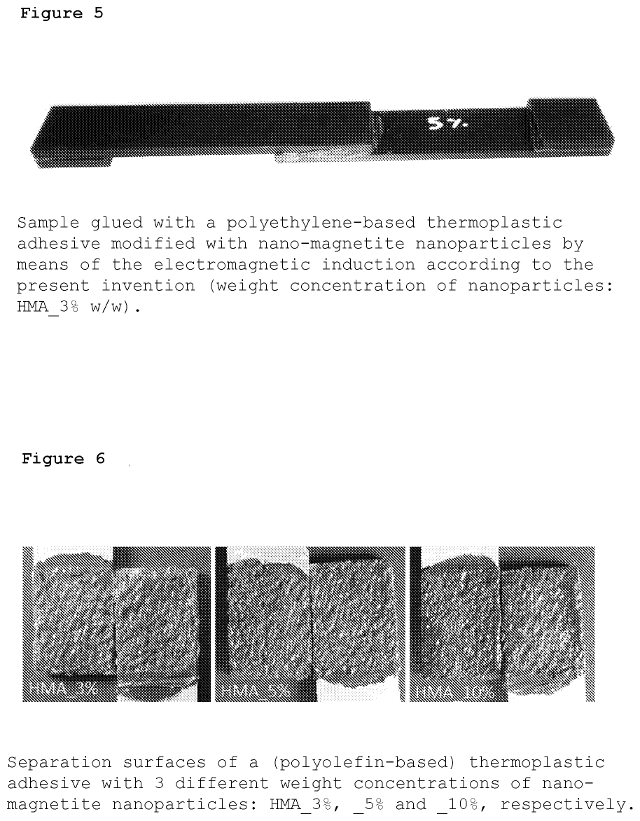

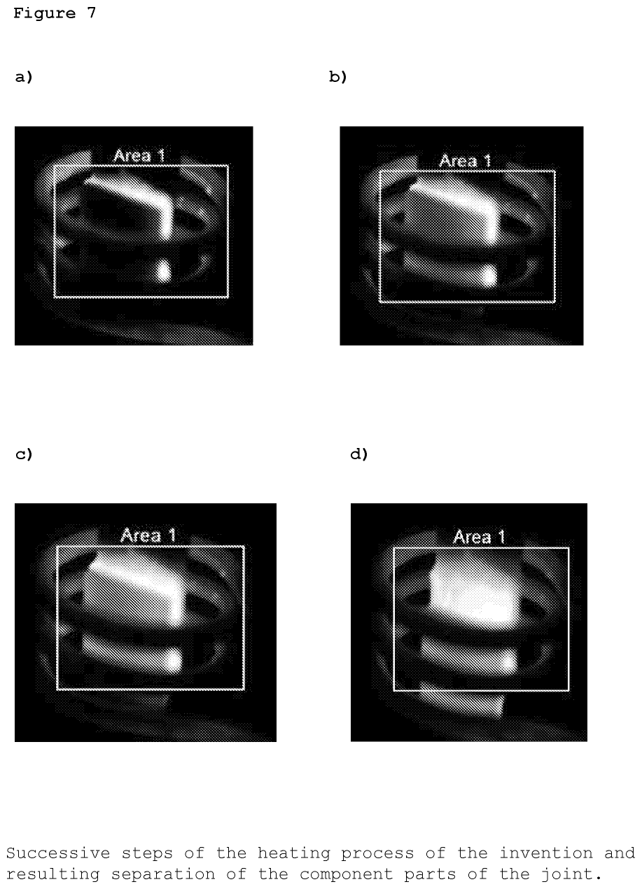

The annexed FIG. 4 shows a schematic view of a pancake coil of the invention with a schematized representation of a substrate cooling system that may be possibly used in association therewith. As previously specified, the cooling system preferably consists of an air jet (possibly a jet of inert gas) which can be oriented over the substrate at a controlled speed based on the substrate material's sensitivity to electromagnetic fields. The cooling system is moved coherently with the inductor head (i.e., the pancake coil). The arrows in FIG. 4 indicate the possibility for the inductor to move in both directions over the gluing line.

In a further embodiment of the invention, the same technology as described above, operating in the same manner, can also be used for directly joining together thermoplastic components, wherein the same nanoparticles of the invention are applied onto the area(s) to be glued. The nanoparticles may be applied, for example, by spraying a mixture of thermoplastic material and nanoparticles onto the points where gluing/joining must be obtained. In this way, the heating of the nanoparticles, caused by the electromagnetic inductor, results in localized heating that allows melting the polymer only locally and obtaining the gluing effect under light pressure. In addition to deposition by spraying, the nanoparticles may also be applied by means of nanoparticles of the same nature deposited on a strip of compatible scotch tape, or by direct deposition of the nanoparticles onto the thermoplastic component, or even through the use of more sophisticated sputtering technologies allowing for localized deposition of the nanoparticles onto the surface to be glued.

In substance, therefore, the present invention is aimed at advantageously implementing the following application points at the industrial level:

1. An industrial process for gluing/joining at least two plastic components or substrates by means of at least one hot-melt thermoplastic adhesive modified by adding an effective amount of nano-magnetite nanoparticles, the process comprising:
applying said at least one modified thermoplastic adhesive to a surface of the first one of said at least two plastic components on the desired gluing line or point(s);
laying the second one of said at least two plastic components over the first one at the desired gluing line or point(s);
externally running a pancake coil-type electromagnetic inductor on the desired gluing line or point(s), while conveying the electromagnetic radiation thereon until the desired fluidization or melting of said adhesive is obtained;
at the same time, exerting pressure on the second one of said at least two components until a uniform distribution of the fluidized or melted adhesive is obtained at the desired gluing locations;
removing said magnetic inductor and cooling/letting cool said fluidized or melted adhesive to give a solid body stuck to both the first and second ones of said at least two plastic components;
repeating the above-described procedure in case further plastic components are to be glued to said at least two described components.

2. The process according to point 1, in which said at least two plastic components or substrates are of any type, shape and size, selected from the group consisting of polypropylene, polyethylene, and copolymers thereof.

3. The process according to point 1 or 2, wherein said at least one modified thermoplastic adhesive contains from 3% to 30% w/w of nano-magnetite nanoparticles; said nano-magnetite nanoparticles having a mean size <50 nm, preferably in the range of 12 to 50 nm.

4. The process according to any one of points 1-3, wherein the pancake coil-type electromagnetic inductor consists of a flat coil of any shape and size suitable for the desired type of plastic material and gluing; said shape being round or square or rectangular, and so on.

5. An industrial process for separating plastic components which have been pre-glued by means of the above-described modified hot-melt thermoplastic adhesive, comprising:
externally running a pancake coil-type electromagnetic inductor on the gluing line or point(s) of said plastic components, while conveying the electromagnetic radiation thereon, until the desired fluidization or melting of said adhesive is obtained;
mechanically separating the surfaces of said pre-glued plastic components.

6. The process according to point 5, wherein said at least two plastic components or substrates are of any type, shape and size, preferably selected from the group consisting of polypropylene, polyethylene, and copolymers thereof.

7. The process according to point 5 or 6, wherein said at least one modified thermoplastic adhesive contains from 3% to 30% w/w of nano-magnetite nanoparticles; said nano-magnetite nanoparticles having a mean size <50 nm, preferably in the range of 12 to 50 nm.

8. The process according to any one of points 5-7, wherein the pancake coil-type electromagnetic inductor consists of a flat coil of any shape and size suitable for the desired type of plastic material and pre-gluing to be treated; said shape being round or square or rectangular, and so on.

9. An industrial process for repairing the gluing/junction of plastic components/substrates in which said gluing/junction is damaged or broken, comprising:
externally running a pancake coil-type electromagnetic inductor on the damaged or broken gluing line or point(s) of said plastic components, while conveying the electromagnetic radiation thereon, until the desired fluidization or melting of said adhesive is obtained;
letting said fluidized or melted adhesive flow and uniformly fill the damaged or broken sections of the previous gluing;
if necessary, applying additional pressure until a uniform distribution of the fluidized or melted adhesive to be repaired is achieved at the gluing locations;
removing said magnetic inductor and cooling/letting cool said fluidized or melted adhesive to give a solid body which is again evenly stuck to the plastic components.

10. The process according to point 9, wherein said plastic components or substrates are of any type, shape and size, selected from the group consisting of polypropylene, polyethylene, and copolymers thereof.

11. The process according to point 9 or 10, wherein said at least one modified thermoplastic adhesive contains from 3% to 30% w/w of nano-magnetite nanoparticles; said nano-magnetite nanoparticles having a mean size <50 nm, preferably in the range of 12 to 50 nm.

12. The process according to any one of points 9-11, wherein the pancake coil-type electromagnetic inductor consists of a flat coil of any shape and size suitable for the type of plastic material and the damaged or broken type of gluing to be repaired; said shape being round or square or rectangular, and so on.

### Advantages of the Invention

This invention ensures that the gluing and/or separation of the components/substrates, preferably made of plastic material (but possibly also of composite materials containing any type of fibers, and/or metallic materials, and/or combinations thereof) through the use of the modified thermoplastic adhesives (preferably of the hot-melt type) of the present invention can be achieved by heating the modified thermoplastic adhesive locally without causing any damage to the components to be glued or already glued together. This technique also makes it possible to use particular gluing lines and to separate components in which the adhesive material is not in view: this is a peculiarity that traditional separation systems lack.

With reference to the prior art, this technique specifies and solves the problems related to the gluing and separation, to the use of a minimal amount of iron oxide nanoparticles and to the overheating of the components/substrates to be glued. Said prior art does not specify the exact specific size of the nanoparticles to be used, the shape of the inductor coil (which is the element which gives the shape to the electromagnetic field and which is of fundamental importance to obtain a fast gluing and/or separation process), and the main parameters of the electromagnetic induction process, which are essential for a fast gluing and/or separation process and which consent savings in terms of cost of the nanoparticles and of the process. The gluing and/or separation technique of the present invention make use of particles of less than 50 nm in size, preferably 12 to 50 nm, within specific dimensional ranges, because they allow for a faster, and hence less detrimental, heating, which results in lower process costs. Moreover, since the particles represent the heat source, the smaller their size the higher their number within the adhesive, and hence faster the heating and hence faster the gluing and/or the separation. Another problem that the prior art does not solve is the substrate overheating; namely, the prior art specifies that heating must be such as to not induce overheating in the substrates. Such overheating must be avoided because, depending on the material under use, it may lead to expansion of the material or (also permanent) thermal damage, which may result in improper gluing or sudden failure, e.g., delamination of composite materials. With the technology of the present invention, the substrates, whichever their nature, are preferably cooled by a jet of compressed air, the velocity of which is adjusted according to the substrate's sensitivity to electromagnetic fields. In particular, in the case of plastic materials, the cooling system may be omitted because plastics are not sensitive to electromagnetic fields. The substrates will thus operate at a constant temperature and close to room temperature, ensuring optimal gluing.

### INDUSTRIAL APPLICABILITY

The present invention provides a reliable, easy-to-implement, low-cost industrial process for gluing/joining components/substrates, preferably made of plastic, through the use of a thermoplastic adhesive modified as described in the present description and in the appended claims and/or for separating said pre-glued components without causing any damage to the components themselves, thus allowing for recycling, reusing, waste reducing thereof, and/or for repairing said gluing/junctions. In particular, the said process makes it possible to separate glued components for reuse, the selective recycling thereof (e.g., based on the material types) and the reducing of production wastes. Furthermore, said process ensures achieving a separation without damaging the used components.

The technology of the present invention can be totally automated and is suitable for large volumes, i.e., for use on an industrial scale.

The technology of the present invention allows for a considerable reduction in the spaces occupied in the work environment.

This technology also allows for continuous-line operations when the components need to be subjected to further processing, thus avoiding storage costs and consenting automation of all operations. Instead of being applied by means of a hot-melt gun, the adhesive may also be applied in solid-form strips and then be heated by the inductor robot, thereby saving the spaces that would otherwise be occupied during the heating phase.

The present invention can be used in all the field in which materials of any kind, particularly, preferably plastic materials, are to be glued.

One application of great interest of the present invention concerns, for example, the automotive industry, where the assembly times are very short, and this activity would provide a substantial reduction in times and spaces.

1. An industrial process for gluing/joining at least two plastic components or substrates by means of at least one hot-melt thermoplastic adhesive modified by adding an effective amount of nano-magnetite nanoparticles, the process comprising:
applying said at least one modified thermoplastic adhesive to a surface of a first one of said at least two plastic components on a desired gluing line(s) or point(s);
laying the second one of said at least two plastic components over the first one in contact with the desired gluing line(s) or point(s);
externally running a pancake coil-type electromagnetic inductor on the desired gluing line(s) or point(s), while conveying the electromagnetic radiation thereon until the desired fluidization or melting of said adhesive is obtained;
at the same time, exerting a pressure on the second one of said at least two components until a uniform distribution of the fluidized or melted adhesive at the desired gluing locations is obtained;
removing said magnetic inductor and cooling/letting cool said fluidized or melted adhesive to give a solid body stuck to both the first one and the second one of said at least two plastic components;
repeating the above-described process in case it is desired gluing further plastic components to said at least two described components.

2. The process according to claim 1, wherein said at least two plastic components or substrates are of any type, shape and size, selected from the group consisting of polypropylene, polyethylene, and copolymers thereof.

3. The process according to claim 1, wherein said at least one modified thermoplastic adhesive contains from 3% to 30% w/w of nano-magnetite nanoparticles; said nano-magnetite nanoparticles having a mean size <50 nm.

4. The process according to claim 1, wherein the pancake coil-type electromagnetic inductor consists of a flat coil of any shape and size suitable for the desired type of plastic material and gluing.

5. An industrial process for separating plastic components which have been pre-glued by means of the modified hot-melt thermoplastic adhesive according to claim 3, comprising:
externally running a pancake coil-type electromagnetic inductor on the gluing line(s) or point(s) of said plastic components, while conveying the electromagnetic radiation thereon, until the desired fluidization or melting of said adhesive is obtained;
mechanically separating the surfaces of said pre-glued plastic components.

6. The process according to claim 5, wherein said plastic components or substrates are of any type, shape and size, selected from the group consisting of polypropylene, polyethylene, and copolymers thereof.

7. The process according to claim 5, wherein said at least one modified thermoplastic adhesive contains from 3% to 30% w/w of nano-magnetite nanoparticles; said nano-magnetite nanoparticles having a mean size <50 nm.

8. The process according to claim 5, wherein the pancake coil-type electromagnetic inductor consists of a flat coil of any shape and size suitable for the type of plastic material and to the type of pre-gluing to be treated.

9. An industrial process for repairing the gluing/junction of plastic components/substrates in which said gluing/junction is damaged or broken, comprising:
externally running a pancake coil-type electromagnetic inductor on the damaged or broken gluing line(s) or point(s) of said plastic components, while conveying the electromagnetic radiation thereon, until the desired fluidization or melting of said adhesive is obtained;
letting said fluidized or melted adhesive flow and uniformly fill the damaged or broken sections of the previous gluing;
if necessary, applying a further pressure until the uniform distribution of the fluidized or melted adhesive at the gluing locations to be repaired is achieved;
removing said magnetic inductor and cooling/letting cool said fluidized or melted adhesive to give a solid body which is again evenly stuck to the plastic components.

10. The process according to claim 9, wherein said plastic components or substrates are of any type, shape and size, selected from the group consisting of polypropylene, polyethylene, and copolymers thereof.

11. The process according to claim 9, wherein said at least one modified thermoplastic adhesive contains from 3% to 30% w/w of nano-magnetite nanoparticles; said nano-magnetite nanoparticles having a mean size <50 nm.

12. The process according to claim 9, wherein the pancake coil-type electromagnetic inductor consists of a flat coil of any shape and size suitable for the type of plastic material and the type of damaged or broken gluing to be repaired.

13. The process according to claim 2, wherein said at least one modified thermoplastic adhesive contains from 3% to 30% w/w of nano-magnetite nanoparticles; said nano-magnetite nanoparticles having a mean size <50 nm.

14. The process according to claim 3, wherein said nano-magnetite nanoparticles having a mean size in a range of 12 nm to 50 nm.

15. The process according to claim 4, wherein said shape of said flat coil is round, square, or rectangular.

16. The process according to claim 10, wherein said at least one modified thermoplastic adhesive contains from 3% to 30% w/w of nano-magnetite nanoparticles; said nano-magnetite nanoparticles having a mean size <50 nm.

17. The process according to claim 11, wherein said nano-magnetite nanoparticles having a mean size in a range of 12 nm to 50 nm.

18. The process according to claim 10, wherein the pancake coil-type electromagnetic inductor consists of a flat coil of any shape and size suitable for the type of plastic material and the type of damaged or broken gluing to be repaired.

19. The process according to claim 12, wherein said shape of said flat coil is round, square, or rectangular.
